(19) United States
(12) Patent Application Publication
(10) Pub. No.: US 2015/0029277 A1
(43) Pub. Date: Jan. 29, 2015

(54) WAVELENGTH FILTERS FOR DRYERS OF PRINTING SYSTEMS

(71) Applicants: Stuart J. Boland, Denver, CO (US); Sean K. Fitzsimons, Thornton, CO (US); Scott R. Johnson, Erie, CO (US); William Edward Manchester, Erie, CO (US); Casey E. Walker, Boulder, CO (US)

(72) Inventors: Stuart J. Boland, Denver, CO (US); Sean K. Fitzsimons, Thornton, CO (US); Scott R. Johnson, Erie, CO (US); William Edward Manchester, Erie, CO (US); Casey E. Walker, Boulder, CO (US)

(73) Assignee: RICOH COMPANY, LTD, Tokyo (JP)

(21) Appl. No.: 13/948,333

(22) Filed: Jul. 23, 2013

(51) Int. Cl. B41J 11/00

(52) U.S. Cl. CPC B41J 11/002
USPC 347/102

(57) ABSTRACT

Systems and methods are provided for filtering wavelengths of energy in a dryer of a printing system. The system comprises a dryer of a printing system that includes a heating element and an optical filter. The heating element is within an interior of the dryer and is able to radiate broad spectrum energy onto a web of printed media as the web travels through the interior. The optical filter is located within the interior between the heating element and the web, and the optical filter is able to prevent specific wavelengths of the energy from reaching the web while allowing other wavelengths of the energy to pass through.

### FIELD OF THE INVENTION

The invention relates to the field of production printing, and in particular, to radiant drying of ink applied to print media.

### BACKGROUND

Entities with substantial printing demands typically use a production printer. A production printer is a high-speed printer used for volume printing (e.g., one hundred pages per minute or more). Production printers include continuous-forms printers that print on a web of print media stored on a large roll.

A production printer typically includes a localized print controller that controls the overall operation of the printing system, and a print engine (sometimes referred to as an “imaging engine” or a “marking engine”). The print engine includes one or more printhead assemblies, with each assembly including a printhead controller and a printhead (or array of printheads). An individual printhead includes multiple tiny nozzles (e.g., 360 nozzles per printhead depending on resolution) that are operable to discharge ink as controlled by the printhead controller. A printhead array is formed from multiple printheads that are spaced in series across the width of the web of print media.

While the printer is in operation, the web of print media is quickly passed underneath the nozzles, which discharge wet ink at intervals to form pixels on the web. A radiant dryer may be installed downstream from the printer to dry this wet ink. The radiant dryer assists in drying the ink on the web after the web leaves the printer. A typical radiant dryer includes an array of broad spectrum heat lamps (e.g., heat lamps that emit infrared (IR) energy and heat). The heat lamps help to dry the ink onto the web as the web passes through the dryer.

Even when a web of print media moves quickly through a dryer, it has a chance of scorching or burning while drying. This is because different inks applied to the web will absorb energy differently. For example, black inks typically absorb more energy from the dryer than lighter inks This means that after the same distance of travel through the dryer, the black ink can be in danger of scorching while the lighter inks are still wet. Such scorching and/or dampness can cause permanent warping and distortion of the web.

### SUMMARY

Embodiments described herein utilize one or more optical filters to selectively prevent specific wavelengths of electromagnetic energy (e.g., IR energy) from striking a web of print media within a radiant dryer. The filter only allows certain wavelengths of energy to strike the web. By blocking wavelengths of energy that are absorbed differently by different colors of inks, the heating of the inks can be made more uniform. This in turn reduces the chances of scorching, burning, warping, and distortion at the web, while allowing all inks to dry uniformly.

One embodiment is a dryer of a printing system. The dryer includes a heating element and an optical filter. The heating element is within an interior of the dryer and is able to radiate broad spectrum energy onto a web of printed media as the web travels through the interior. The optical filter is located within the interior between the heating element and the web, and the optical filter is able to prevent specific wavelengths of the energy from reaching the web while allowing other wavelengths of the energy to pass through.

Another embodiment is a method. The method includes operating a heating element within an interior of a dryer to radiate broad spectrum energy onto a web of printed media as the web travels through the interior. The method also includes optically filtering energy from the heating element with a filter located between the heating element and the web to prevent specific wavelengths of the energy from reaching the web while allowing other wavelengths of the energy to pass through.

Other exemplary embodiments (e.g., methods and computer-readable media relating to the foregoing embodiments) may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates an exemplary continuous-forms printing system.

FIG. 2 is a graph illustrating exemplary measured absorbance values of different colors of inks

FIG. 3 is a block diagram of a drying system in an exemplary embodiment.

FIG. 4 is a flowchart illustrating a method for operating a drying system in an exemplary embodiment.

FIG. 5 is a graph illustrating transmittance properties of an exemplary hot mirror that can be used as an optical filter.

FIGS. 6-9 are block diagrams illustrating various exemplary implementations of optical filtering systems.

FIG. 10 is a diagram of an exemplary drying system.

FIG. 11 illustrates a processing system operable to execute a computer readable medium embodying programmed instructions to perform desired functions in an exemplary embodiment.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

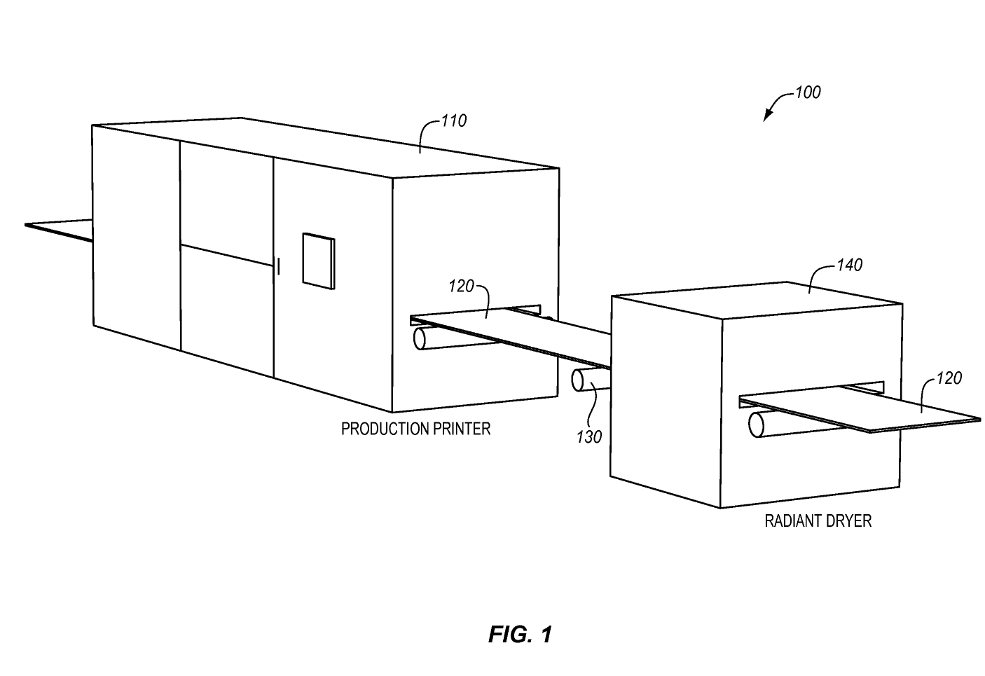

FIG. 1 illustrates an exemplary continuous-forms printing system 100. Printing system 100 includes production printer 110, which is operable to apply ink onto a web of continuous-form print media 120. As used herein, the word “ink” is used to refer to any suitable marking fluid that can be applied by a printer onto web 120 (e.g., aqueous inks, oil-based paints, etc.). Printer 110 may comprise an inkjet printer that applies colored inks, such as Cyan (C), Magenta (M), Yellow (Y), and Key (K) black inks The ink applied by printer 110 to web 120 is wet, meaning that the ink may smear if it is not dried before further processing. One or more rollers 130 position web 120 as it travels through printing system 100.

To dry the ink, printing system 100 also includes drying system 140 (e.g., a radiant dryer). Drying system 140 can be installed in printer 110, or can be implemented as an independent device downstream from printer 110 (as shown in FIG. 1). Web 120 travels through drying system 140 where an array of heating elements such as heat lamps (not shown) radiate thermal energy to dry the ink onto web 120.

However, drying ink onto web 120 is not a simple process. Some colors of ink absorb more radiant energy while traveling through a drying system than other colors of ink. For example, “K black” ink and other dark colors are generally more absorbent than lighter colors. Because the darker colors absorb more energy from the heating elements, they can reach a higher temperature than other colors of ink while drying. This means that dark inks may dry completely and overheat to the point that they risk scorching before lighter inks have fully dried.

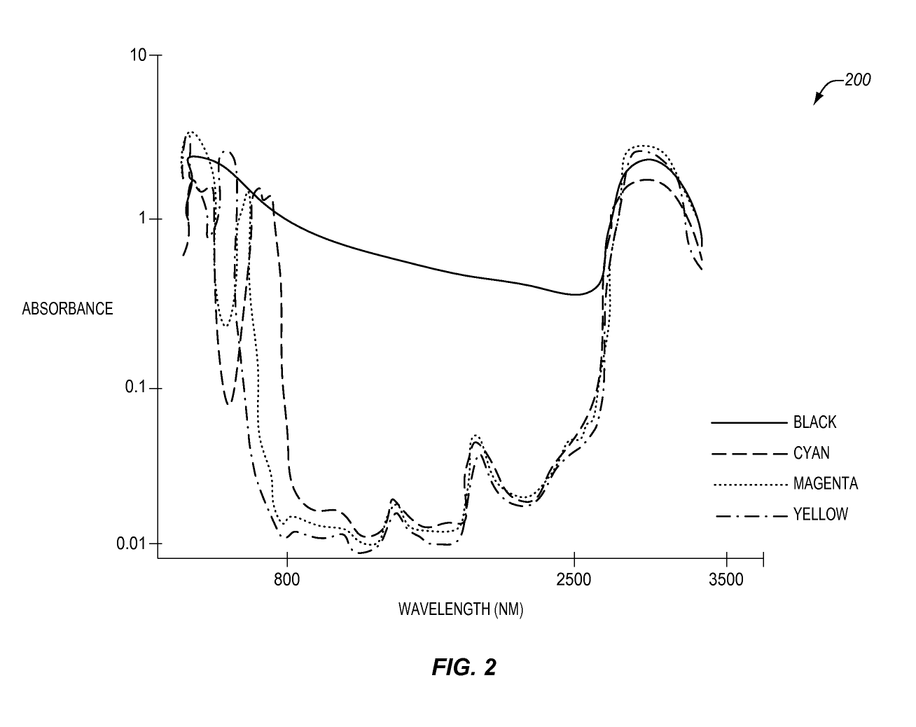

Fortunately, within certain wavelength ranges the absorption characteristics of different colors of ink are much more uniform. FIG. 2 is a graph 200 illustrating exemplary measured absorbance values of different colors of inks Specifically, graph 200 illustrates absorbance values for C, M, Y, and K black inks as a function of wavelength of light/energy. FIG. 2 shows that absorbance values for wavelengths above about 2700 nanometers (nm) tend to be fairly even between inks, and the same is true to some degree for wavelengths below about 600 nm. However, there is a large disparity in absorbance values between inks in the range of about 800 nm to about 2500 nm. This substantially corresponds to what is known as the near-Infrared (IR) range (800-2500 nm).

Since radiant dryers use heat lamps that radiate visible and infrared light/energy across a large range of frequencies (including the near-IR range), the heat lamps themselves contribute to uneven drying between different colors of ink. To address this problem, drying system 140 has been enhanced with an optical filter that blocks the transmission of near-IR wavelengths, while permitting the transmission of other wavelengths. This in turn means that inks of different colors will undergo more uniform heating, which prevents dark inks from getting too hot while other inks are drying.

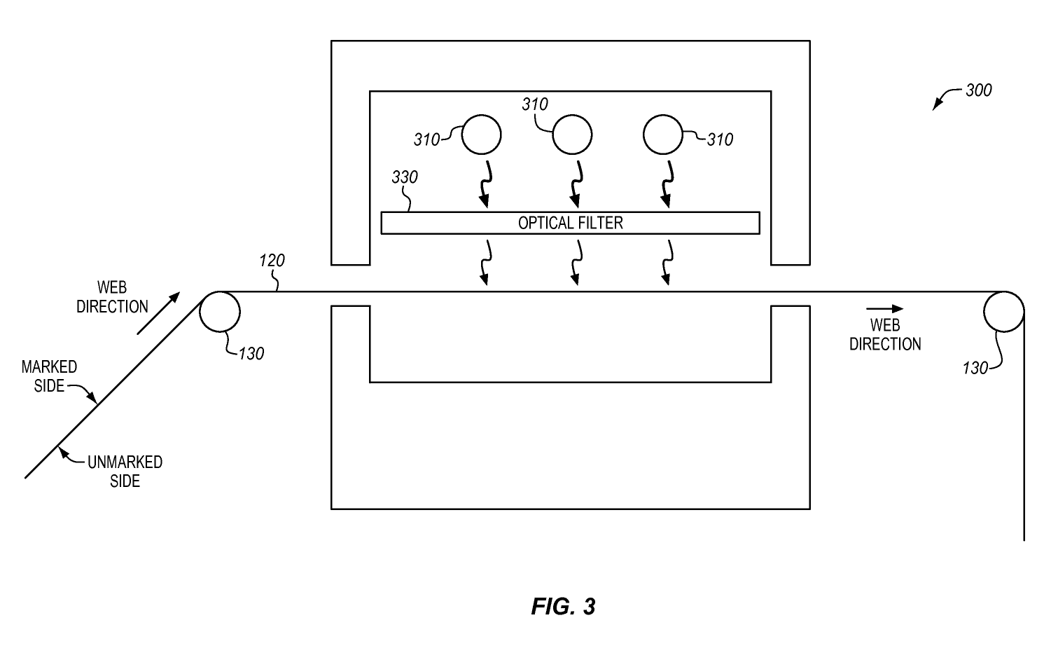

FIG. 3 is a diagram of a drying system 300 in an exemplary embodiment. Drying system 300 receives web of printed media 120, which has been marked by an upstream printer and tensioned by rollers 130. Drying system 300 operates one or more broad spectrum heating elements 310 to dry ink onto web 120. As used herein, the term broad spectrum refers to a range of wavelengths that includes both near-IR components and other wavelength components (e.g., any of ultraviolet, visible light, mid-IR, far-IR, etc.).

Radiant energy from heating elements 310 can optionally be reflected by thermal reflectors towards web 120. Utilizing reflectors can help to reduce waste heat, and can also keep internal components of drying system 300 from overheating. For example, reflectors can be arranged to catch excess light from heating elements 310, within drying system 300, and to reflect that excess light back towards web 120 to allow for more efficient heating.

Drying system 300 has been enhanced to include optical filter 330. Optical filter 330 is positioned between heating elements 310 and web 120. Therefore optical filter 330 catches energy radiated from heating elements 310 before the energy strikes web 120. Optical filter 330 absorbs and/or reflect wavelengths of energy (e.g., wavelengths that are substantially in the near-IR range), while permitting other wavelengths of energy to pass through. Preventing near-IR energy from striking web 120 ensures a more uniform heating of inks of different colors.

Optical filter 330 may comprise any system, component, or device suitable to prevent specific wavelengths of energy (emitted by heating elements 310) from reaching web 120. For example, optical filter 330 may comprise an absorptive filter (e.g., an “IR cut-off” filter), a dichroic/interference filter (e.g., a “hot mirror”), or any suitable combination thereof

While specific elements are described with regard to printing system 100 of the above figure, the arrangement and type of elements used in these figures may vary as desired in order to dry webs of print media. For example, different numbers, arrangements, and types of each component may be used as desired.

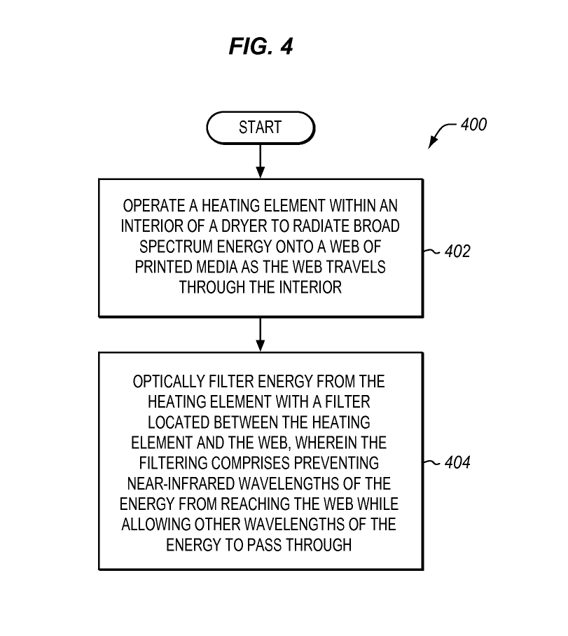

Illustrative details of the operation of drying system 300 will be discussed with regard to FIG. 4. Assume, for this embodiment, that an upstream printer has marked web 120, and that web 120 is being received at drying system 300 for processing.

FIG. 4 is a flowchart illustrating a method 400 for operating a drying system in an exemplary embodiment. The steps of method 400 are described with reference to drying system 300 of FIG. 3, but those skilled in the art will appreciate that method 400 may be performed in other systems. The steps of the flowcharts described herein are not all inclusive and may include other steps not shown. The steps described herein may also be performed in an alternative order.

In step 402, heating elements 310 are operated to radiate broad spectrum energy onto web 120 as web 120 travels across the interior of drying system 300. In one embodiment, heating elements 310 are heat lamps that are electrically powered to radiate thermal energy to heat web 120.

In many drying systems, the radiant energy applied by heating elements 310 is the primary source of energy that dries web 120. However, because some marked portions of print media absorb near-IR energy differently than others, web 120 can quickly experience large differences in temperature between different regions (e.g., between light inked regions and dark inked regions).

To address this problem optical filter 330, which is located/positioned in between heating elements 310 and web 120 within dryer 300, optically filters energy from heating elements 310 in step 404. One design of optical filter 330 prevents wavelengths that are substantially in the near-IR range from reaching web 120, yet also allows other wavelengths of energy (e.g., visible light, mid-IR, etc.) to pass through. For example, optical filter 330 may comprise a hot mirror that reflects near-IR energy back towards heating elements 310.

Method 400 intentionally blocks some infrared energy, preventing it from heating web 120. By performing this counter-intuitive process of preventing some IR energy from reaching the web, heating for each color of ink can be made more uniform. This in turn means that temperature differences between different portions of web 120 can be reduced substantially. Thus, web 120 can undergo further heating (e.g., in order to fully dry lighter inks) within the drying system while substantially reducing the risk of overheating, burning, or scorching dark regions.

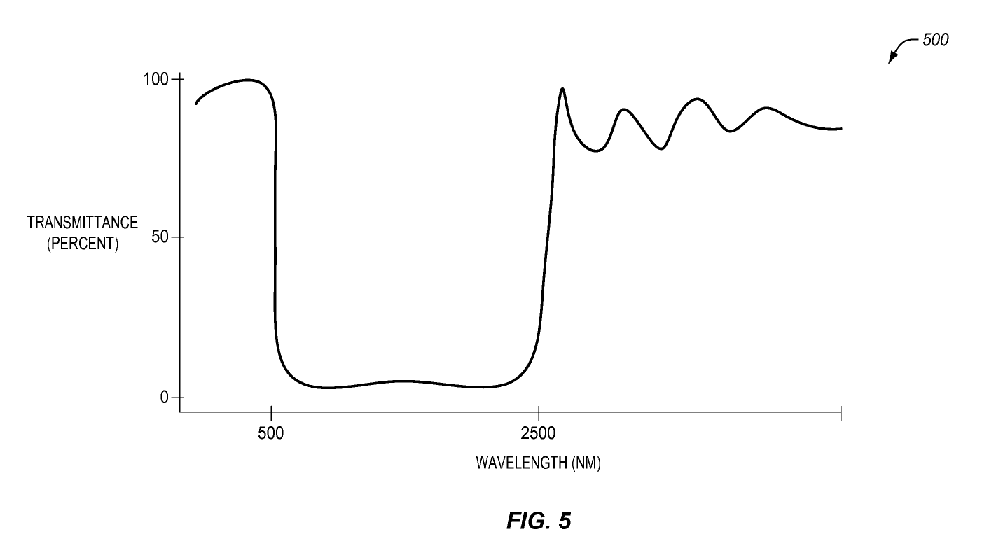

FIG. 5 is a graph 500 illustrating transmittance properties of an exemplary hot mirror that can be used as an optical filter. A hot mirror is a dichroic filter that reflects near-IR transmissions back towards their source. According to graph 500, because a hot mirror reflects a wide range of near-IR wavelengths, it can be used to block light that would be absorbed differently by different colors of ink (the different absorption characteristics of inks is shown for example in graph 200 of FIG. 2). At the same time, a hot mirror can allow other wavelengths of energy through it to heat a web of print media (e.g., mid-IR and/or some visible light).

A hot mirror can provide an added benefit to radiant dryers. By reflecting near-IR light back towards the heating elements, a hot mirror can be used to increase the operating temperatures of the heating elements in a radiant dryer, which can increase their efficiency.

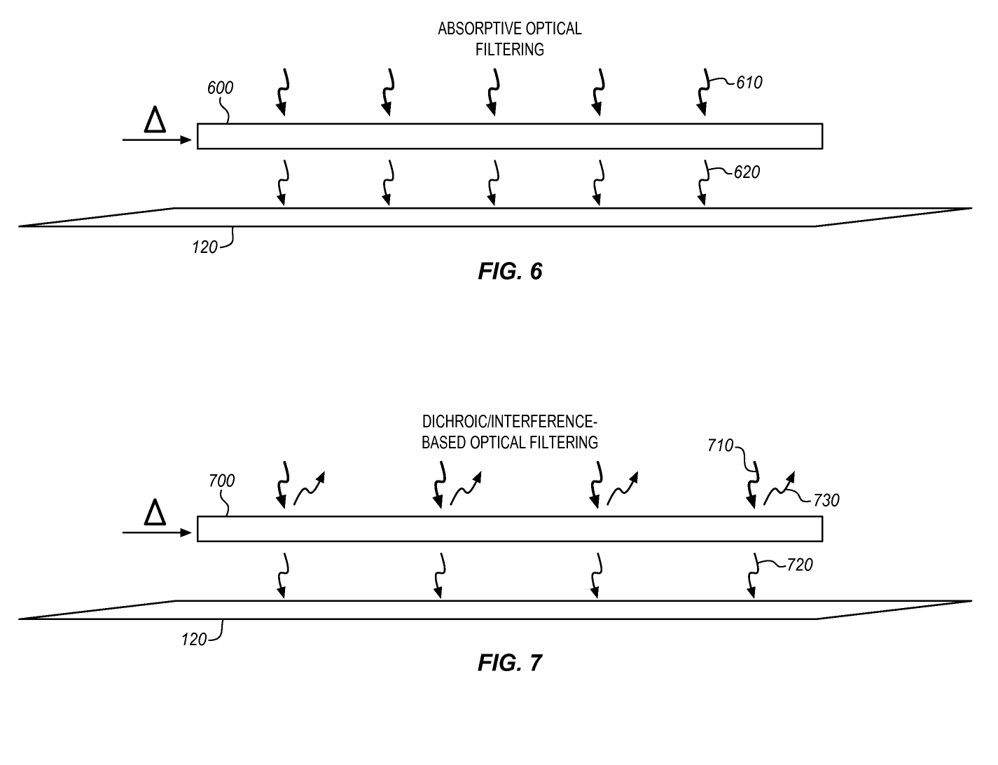

FIGS. 6-9 are block diagrams illustrating various exemplary implementations of optical filtering systems. FIG. 6 illustrates an exemplary absorptive optical filter 600. In absorptive optical filters, energy 610 radiated from a heating element is absorbed and turned into heat which increases the temperature of the optical filter. Here, the influx of heat experienced by optical filter 600 as it absorbs near-IR energy is indicated by the Δ symbol at the far left. The energy that has not been filtered and has instead been transmitted by optical filter 600 to web 120 is indicated as light 620.

FIG. 7 illustrates an exemplary dichroic optical filter 700. Dichroic filters are also known as “interference” filters. Instead of absorbing certain wavelengths of energy, dichroic filters reflect them back towards their source. Here, some wavelengths of energy 710 radiated from a heating element are transmitted to web 120 (depending on their wavelength) as energy 720. Meanwhile, other wavelengths of energy 710 (i.e., near-IR portions of radiation 710) are reflected back as light 730. Dichroic filters experience less heating than absorptive filters, but still experience some heating. In FIG. 7, the influx of heat is represented by the A symbol at the far left.

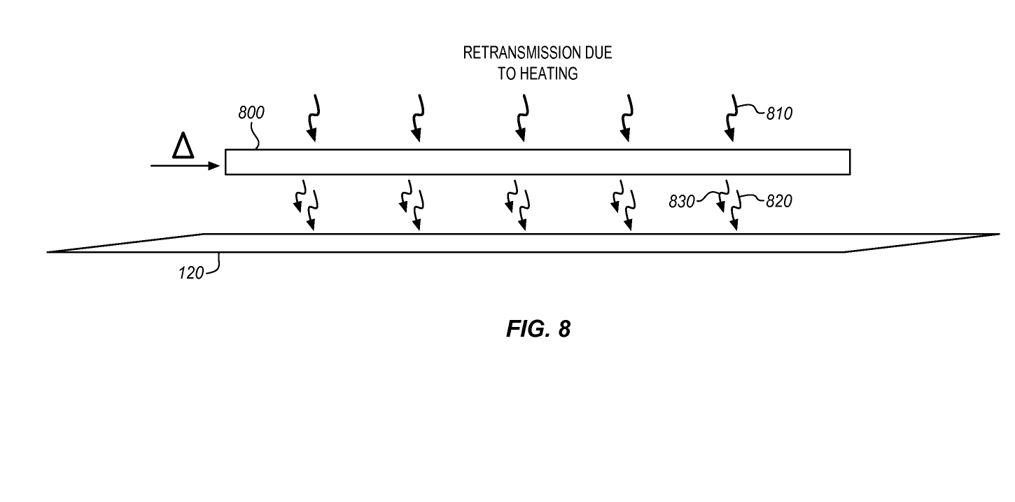

FIG. 8 illustrates an exemplary re-transmission process occurring at an optical filter 800. Retransmission processes can occur at both dichroic and absorptive filters. Without retransmission, optical filter 800 functions as expected to block a portion of energy 810 and to transmit the remaining portion as energy 820. However, since optical filter 800 heats up during normal operations, it also emits what is known as “black body radiation” 830 based on its temperature. The wavelength and intensity of the black body radiation depends upon the final operating temperature of optical filter 800 while the drying system is being operated. In order to prevent filter 800 from re-transmitting near-IR wavelengths onto web 120, a number of variables can be adjusted. For example, the energy applied to the heating elements of the drying system can be kept below (or above) a specific level, optical filter 800 may be placed a certain distance away from the heating elements, optical filter 800 may include a passive cooling element (e.g., a heat sink and/or other heat exchanger) in order to dissipate heat and prevent black body radiation, or optical filter 800 may be actively cooled by a fan or other cooling system.

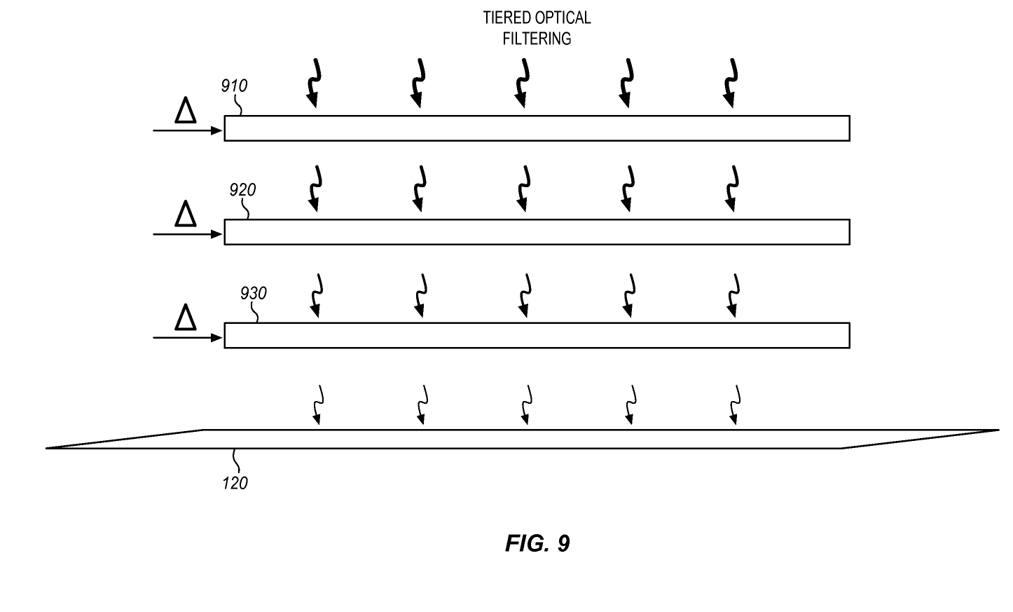

FIG. 9 illustrates an exemplary multi-layer optical filter in an exemplary embodiment. According to FIG. 9, three different filters (910, 920, and 930) are used in series to filter near-IR energy out of incoming radiation from a heating element. In this embodiment, each filter is used to filter out a different set of wavelengths in the near-IR band. Thus, when the filters are used in series, the entire near-IR range is blocked from reaching web 120. For example, filter 910 may block the 800-1400 nm range, filter 920 may block the 1400-2000 nm range, and filter 930 may block the 2000-2500 nm range. In FIG. 9, the influx of heat to each filter is represented by the A symbols at the far left.

### EXAMPLES

In the following examples, additional processes, systems, and methods are described in the context of a drying system that uses filters to enhance the drying process.

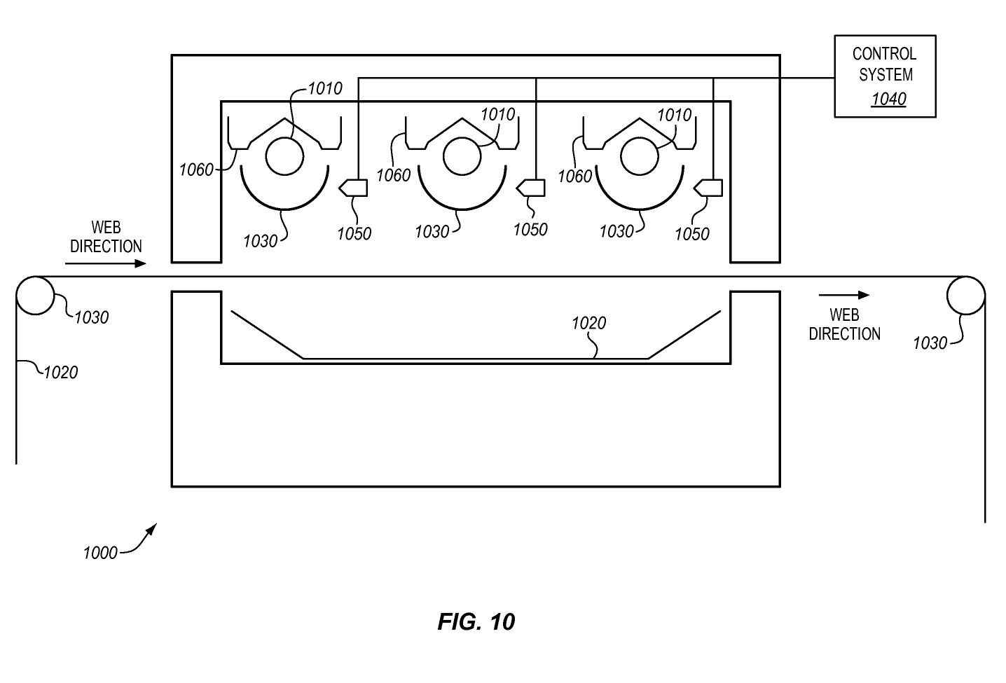

FIG. 10 is a diagram of a further drying system in an exemplary embodiment. According to FIG. 10, web 1020 comprises a web of paper that has been inked by an upstream continuous-forms inkjet printer and positioned by rollers 1030. The ink on web 1020 is still wet as it enters drying system 1000.

As web 1020 travels through drying system 1000 at a linear velocity of up to ten feet per second, web 1020 is heated by radiant heat lamps 1010. In this embodiment, heating elements 1010 comprise cylindrical heat lamps that have a circular cross section. Specifically, radiant heat lamps 1010 comprise tungsten halogen bulbs having filaments that are heated to 3300 Kelvin. As such, radiant heat lamps 1010 emit light/energy at a broad range of frequencies, including the near-IR band. Reflectors 1060 serve to reflect the energy generated by heat lamps 1010 back towards web 1020.

Hot mirrors 1030 are placed between web 1020 and heat lamps 1010, and reflect near-IR energy back towards heating elements 1010. Meanwhile, hot mirrors 1030 allow other wavelengths of light to pass through them, heating web 1020. Thus, even though the temperature of web 1020 tends to increase as it passes underneath each radiant heat lamp 1010, the temperature differences between colors of ink on web 1020 remain fairly small. This ensures that no unexpected variations in temperature will cause overheating at web 1020.

In order to regulate the temperatures of hot mirrors 1030 and prevent them from overheating, drying system 1000 includes an electronic control system 1040 that operates fans 1050. The fans circulate air in the dryer onto hot mirrors 1030, which keeps hot mirrors 1030 operating below a maximum temperature (e.g., below 200 degrees Celsius). The amount of cooling air applied to each hot mirror 1030 may be constant, may vary based on a measured temperature of the hot mirror, etc.

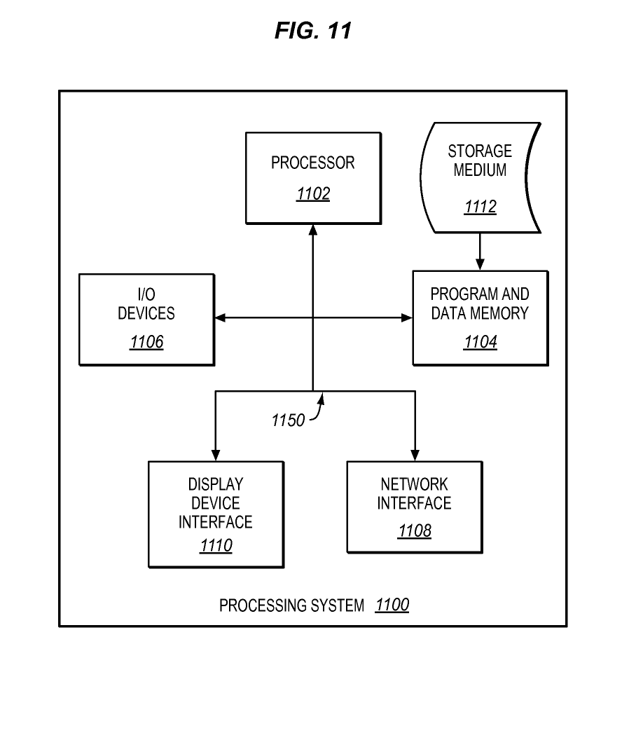

In one particular embodiment, software is used to direct a processing system of control system 1040 of FIG. 10 in order to dynamically regulate the amount of cooling supplied to optical filters 1030 based on their temperatures. FIG. 11 illustrates a processing system 1100 operable to execute a computer readable medium embodying programmed instructions to perform desired functions in an exemplary embodiment. Processing system 1100 is operable to perform the above operations by executing programmed instructions tangibly embodied on computer readable storage medium 1112. In this regard, embodiments of the invention can take the form of a computer program accessible via computer-readable medium 1112 providing program code for use by a computer or any other instruction execution system. For the purposes of this description, computer readable storage medium 1112 can be anything that can contain or store the program for use by the computer.

Computer readable storage medium 1112 can be an electronic, magnetic, optical, electromagnetic, infrared, or semiconductor device. Examples of computer readable storage medium 1112 include a solid state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Processing system 1100, being suitable for storing and/or executing the program code, includes at least one processor 1102 coupled to program and data memory 1104 through a system bus 1150. Program and data memory 1104 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 1106 (including but not limited to keyboards, displays, pointing devices, etc.) can be coupled either directly or through intervening I/O controllers. Network adapter interfaces 1108 may also be integrated with the system to enable processing system 1100 to become coupled to other data processing systems or storage devices through intervening private or public networks. Modems, cable modems, IBM Channel attachments, SCSI, Fibre Channel, and Ethernet cards are just a few of the currently available types of network or host interface adapters. Presentation device interface 1110 may be integrated with the system to interface to one or more presentation devices, such as printing systems and displays for presentation of presentation data generated by processor 1102.

Although specific embodiments were described herein, the scope of the invention is not limited to those specific embodiments. The scope of the invention is defined by the following claims and any equivalents thereof.

We claim:

1. An apparatus comprising:
a dryer of a printing system comprising:
a heating element within an interior of the dryer that is adapted to radiate broad spectrum energy onto a web of printed media as the web travels through the interior; and
an optical filter that is located within the interior between the heating element and the web, wherein the optical filter is adapted to prevent specific wavelengths of the energy from reaching the web while allowing other wavelengths of the energy to pass through.

2. The apparatus of claim 1, wherein:
the optical filter is adapted to prevent near-Infrared (IR) wavelengths of energy from reaching the web while allowing other wavelengths of energy to pass through.

3. The apparatus of claim 1, wherein:
the optical filter comprises a dichroic filter.

4. The apparatus of claim 3, wherein:
the dichroic filter comprises a hot mirror.

5. The apparatus of claim 1, wherein:
the optical filter comprises an absorptive filter.

6. The apparatus of claim 5, wherein:
the absorptive filter comprises multiple layers that are each adapted to block transmission of a different range of wavelengths of the energy.

7. The apparatus of claim 1, wherein:
the optical filter is adapted to block transmission of energy having a wavelength substantially between about 600 nanometers and about 2700 nanometers.

8. The apparatus of claim 1, further comprising:
a heat sink adapted to dissipate heat from the optical filter into the surrounding air.

9. The apparatus of claim 1, further comprising:
a cooling system operable to convectively cool the optical filter with a fluid to reduce the temperature of the optical filter when the dryer is operating.

10. The apparatus of claim 9, wherein:
the cooling system comprises a fan positioned to project a jet of air directly onto the optical filter.

11. A method comprising:
operating a heating element within an interior of a dryer to radiate broad spectrum energy onto a web of printed media as the web travels through the interior; and
optically filtering energy from the heating element with a filter located between the heating element and the web to prevent specific wavelengths of the energy from reaching the web while allowing other wavelengths of the energy to pass through.

12. The method of claim 11, further comprising:
optically filtering to prevent near-Infrared (IR) wavelengths of energy from reaching the web while allowing other wavelengths of energy to pass through.

13. The method of claim 11, wherein:
the optical filtering is performed by use of a dichroic filter.

14. The method of claim 13, wherein:
the optical filtering is performed by use of a hot mirror.

15. The method of claim 11, wherein:
the optical filtering is performed by use of an absorptive filter.

16. The method of claim 15, wherein:
the optical filtering is performed by use of an absorptive filter comprising multiple layers that are each adapted to block transmission of a different range of wavelengths of the energy.

17. The method of claim 11, wherein:
the optical filtering blocks transmission of energy having a wavelength substantially between about 600 nanometers and about 2700 nanometers.

18. The method of claim 11, wherein:
the filter is coupled to a heat sink adapted to dissipate heat from the filter into the surrounding air.

19. The method of claim 11, wherein the method further comprises:
operating a cooling system to convectively cool the filter with a fluid, thereby reducing the temperature of the optical filter when the dryer is operating.

20. The method of claim 19, wherein:
the cooling system comprises a fan positioned to project a jet of air directly onto the filter.
